(19) United States
(12) Patent Application Publication
(10) Pub. No.: US 2023/0398814 A1
(43) Pub. Date: Dec. 14, 2023

(54) TIRE-FORMING FLEXIBLE TUBE, TIRE ASSEMBLY MECHANISM AND METHODS AND SYSTEMS FOR USING SAME

(71) Applicant: Alexei KOSITSIN, Tel Aviv (IL)

(72) Inventor: Alexei KOSITSIN, Tel Aviv (IL)

(21) Appl. No.: 18/032,238

(22) PCT Filed: Oct. 27, 2021
(86) PCT No.: PCT/IL2021/051271

§ 371 Date: Apr. 17, 2023

Related U.S. Application Data
(60) Provisional application No. 63/106,850, filed on Oct. 28, 2020.

(51) Int. Cl. B60C 5/00; B60C 5/10

(52) U.S. Cl. CPC B60C 5/002; B60C 5/10; B60C 2200/10; B60C 2200/12

(57) ABSTRACT

This disclosure relates to tire-forming flexible tubes with first and seconds ends configured to be joined together to form a tire, as well as to locking assemblies, connecting mechanism and method for utilizing same.

### TECHNICAL FIELD

The present disclosure relates generally to assemblable tires, in particular assemblable tires for light vehicles such as manual or electric bicycles and scooters, moped, motorbikes and the like.

### BACKGROUND

One of the main problems with replacing tires of a manual or electric bicycle is that each wheel typically needs to be removed. Moreover, replacing or changing a tire can be a time-consuming, dirtying, and often require a number of tools such as screwdrivers, wrenches, etc.

Furthermore, changing a tire of electric vehicles, such as electric bicycles, electric scooters, and the like, might be even more technically demanding, since disassociating of the motor from the vehicle may be required. Therefore, an inexperienced operator might damage the motor, essentially damaging the whole vehicle.

Accordingly, there remains a need in the art for a device and a method enabling fast and technically simple tire replacing/changing.

### SUMMARY

Aspects of the disclosure, according to some embodiments thereof, relate to a tire-forming elongated flexible tube having a first end and a second end configured to be joined around a wheel, thereby forming a ready-to-use tire.

Advantageously, the tire can be formed from the tire-forming flexible tube without removal of the wheel form the vehicle to which it is attached (e.g., a bicycle or a scooter), requiring a single, easy-to-use assembly tool, such that the assembly procedure can be performed without requiring technical expertise.

Moreover, the tire-forming flexible tube is customizable. That is, due to its elongated shape and uniform structure, the tire-forming flexible tube can be adapted to wheels of different sizes, simply by adjusting the length of the tube. This may advantageously obviate the need of bicycle stores, and the like, to store tires of different sizes. Instead, the tire-forming flexible tube may be rolled, for example on a spool, from which tire-forming sections may be cut.

According to some embodiments, there is provided a tire-forming flexible tube having a first end and a second end, the tire-forming flexible tube comprising an outer layer made of a first elastomeric material, and an inner filament made of a second elastomeric material, the inner filament enclosing a holding tube, wherein the first end and the second end of the tire-forming flexible tube are configured to be joined together to form a tire.

According to some embodiments, the holding tube comprises a wall made of a reinforced polymeric material, the wall forming an open-ended lumen.

According to some embodiments, the first elastomeric material has a higher flexibility and/or lower hardness than the second elastomeric material. According to some embodiments, the first elastomeric material is or includes a hard rubber or other polymeric material. According to some embodiments, the second elastomeric material is or includes a soft rubber or a foam.

According to some embodiments, the inner filament includes one or more longitudinal bores extending along the length of the tire-forming flexible tube, the longitudinal bores configured to increase the flexibility of the tire-forming flexible tube.

According to some embodiments, the tire-forming flexible may have an essentially dome shaped cross-section, wherein the base of the dome is sized and shaped to be received within a rim of a wheel. However, other shapes such as circular or oval are also envisaged and as such within the scope of this disclosure. According to some embodiments, the side walls of the tire-forming flexible tube (e.g at the base of the dome) may include lateral slits, the lateral slits configured to receive a rim frame of the wheel.

According to some embodiments, the has an essentially uniform structure and shape along its length, such that the size of the tire, formed upon joining of the first and second ends, is determinable by adjustment of the length of the tire-forming flexible tube.

According to some embodiments, the wheel is selected from a bicycle wheel, a scooter wheel, a moped wheel a motorcycle wheel or any combination thereof. Each possibility is a separate embodiment.

According to some embodiments, there is provided a locking assembly configured to connect together the first and second ends of a tire-forming flexible tube, such as the herein disclosed tire-forming flexible tube, the locking assembly including a rod configured for insertion into the lumen of the holding tube.

According to some embodiments, the rod may include two or more asymmetrical anchors or a glue on an outer surface thereof. According to some embodiments, a first subset of the two or more asymmetrical anchors, positioned on a first portion of the rod, are oppositely faced relative to a second subset of the two or more asymmetrical anchors positioned on a second portion of the rod. According to some embodiments, the two or more asymmetrical anchors are configured to anchor within the wall of the holding tube and/or within the inner filament, thereby persisting detachment of the joint-together first and second ends.

According to some embodiments, the outer diameter of the rod is sized to fit within the lumen of the holding tube in a tight fit manner.

According to some embodiments, the outer surface of the rod further includes a bulge increasing the outer diameter of the rod, such that when the first portion of the rod is inserted into the lumen of the first end of the tire-forming flexible tube, the bulge serves as a stopper for further insertion. According to some embodiments, the bulge extends circumferentially around the rod. According to some embodiments, the lateral surfaces of the bulge may include an adhesive configured to glue together the first and second ends, when joined.

According to some embodiments, the locking assembly may further include a disk having an adhesive on both its lateral surfaces. According to some embodiments, the disk has an essentially same cross section, as the cross section of the tire-forming flexible tube. According to some embodiments, the disk has a hole with an inner diameter allowing the first portion of the rod to be inserted therethrough.

According to some embodiments, there is provided a tire-forming system comprising including a tire-forming flexible tube, such as the herein disclosed tire-forming flexible tube; a locking assembly, such as the herein disclosed locking assembly; and a connecting mechanism configured to join together the first and second ends of the tire-forming flexible tube. According to some embodiments, the connecting mechanism includes a first grasping element configured to grasp the first end of the tire-forming flexible tube, a second grasping element configured to grasp the second end of the tire-forming flexible tube, and a tightening element configured to interconnect the first and the second grasping elements, wherein the connecting mechanism is configured to juxtapose the first and second ends of the tire-forming flexible tube until joining thereof.

According to some embodiments, the tightening element may be or include a lever. According to some embodiments, the first grasping element may include a ratchet handle configured to act on the lever to juxtapose the first and second ends.

According to some embodiments, the second grasping element includes one or more locking elements configured to prevent the tire-forming flexible tube from escaping the rim of the wheel during the juxtaposition of the first and second ends. According to some embodiments, the one or more locking elements may be or include cam locks.

According to some embodiments, the tire-forming system may further include a one-way valve configured to penetrate the tire-forming flexible tube, so as to allow pumping of air, liquid or liquefied foam into the holding tube.

According to some embodiments, there is provided a method for assembling a tire on a wheel, the method comprising obtaining a tire-forming flexible tube, such as the herein disclosed tire-forming flexible tube; optionally adjusting the length of the tire-forming flexible tube to a length suitable for the wheel; inserting the tire-forming flexible tube into the rim of the wheel; obtaining a rod configured for insertion into the lumen of the holding tube of the tire-forming flexible tube, inserting the first portion of the rod into the first end of the tire-forming flexible tube; inserting a second portion of the rod into the second end of the tire-forming flexible tube; obtaining a connecting mechanism configured to join the first and second ends of the tire-forming flexible tube, the connecting mechanism including a first grasping element configured to grasp the first end of the tire-forming flexible tube, a second grasping element configured to grasp the second end of the tire-forming flexible tube, and a tightening element configured to interconnect the first and the second grasping elements; attaching the connecting mechanism to the tire-forming flexible tube, such that the first grasping element grasps the first end of the tire-forming flexible tube, the second grasping element grasps the second end of the tire-forming flexible tube, and the tightening element interconnects the first and second grasping elements; juxtaposing the first and second ends of the tire-forming flexible tube using the connecting mechanism, until the first and second ends are joined; and removing the connecting mechanism to obtain a wheel with a tire within the rim thereof.

According to some embodiments, the rod including a two or more asymmetrical anchors on an outer surface thereof, wherein a first subset of the asymmetrical anchors, positioned on a first portion of the rod, are oppositely faced relative to second subset of the two or more asymmetrical anchors, positioned on a second portion of the rod. According to some embodiments, inserting the rod into the lumen of the holding tube comprises screwing or pushing the rod into the lumen such that the two or more asymmetrical anchors are anchored within the wall of the holding tube, thereby preventing/resisting detachment of the joined first and second ends.

According to some embodiments, the method further includes sliding a disc over the rod, prior to insertion of the second portion of the rod into the second end of the tire-forming flexible tube, such that the disc be positioned between the first and second ends of the tire-forming flexible tube. According to some embodiments, the disc has an adhesive on both its lateral surfaces, such that when the first and second ends of the tire-forming flexible tube are joined, the adhesive glues the first and second ends together, thereby preventing/resisting detachment of the joined first and second ends.

According to some embodiments, the rod includes a bulge on its outer surface, the bulge positioned between the first and second portions of the rod. According to some embodiments, the inserting of the first portion of the rod into the first end of the tire-forming flexible tube comprises inserting the first portion of the rod until the bulge prevents further insertion.

According to some embodiments, the method further includes inserting a one-way valve into a hole in the rim of the wheel prior to inserting the tire-forming flexible tube into the rim of the wheel. According to some embodiments, the juxtaposing of the first and second ends causes the valve to penetrate the tire-forming flexible tube, such that a first end of the one-way valve is positioned within the lumen of the holding tube.

According to some embodiments, the method further includes pumping air, liquid or liquified foam into the lumen of the holding tube using the one-way valve.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes. It is further noted, that while the stages are presented in a certain order, the order of at least some of the stages may differ. For example, some stages may be performed prior to or simultaneously with stages, presented in the flow chart as happening after that stage. One of ordinary skill in the art will ready identify which stages are sequential and which are adaptive.

FIG. 1 schematically illustrates a cross-sectional view of a tire-forming flexible tube, according to some embodiments.

FIG. 2A schematically illustrates a perspective view of a rod of a locking assembly, according to some embodiments, wherein a first portion of the rod is inserted within a first end of a tire-forming flexible tube, such as the tire-forming flexible tube of FIG. 1.

FIG. 2B schematically illustrates a cross-section view of a tire-forming flexible tube after sealing/juxtaposing according to some embodiments, wherein first and second portions of the rod are inserted within first and second ends of the tire-forming flexible tube such as the tire-forming flexible tube of FIG. 1.

FIG. 2C schematically illustrates a cross-section view of a tire-forming flexible tube after sealing/juxtaposing according to some embodiments, wherein first and second portions of the rod are inserted within first and second ends of the tire-forming flexible tube such as the tire-forming flexible tube of FIG. 1

FIG. 3A schematically illustrates the herein disclosed tire-forming flexible tube prior to insertion/positioning within the rim of a wheel, according to some embodiments.

FIG. 3B schematically illustrates the herein disclosed tire-forming flexible tube during insertion/positioning within the rim of a wheel and a locking assembly, according to some embodiments.

FIG. 3C schematically illustrates a connecting mechanism attached to the first and second ends of the herein disclosed tire-forming flexible tube, prior to joining of the first and second ends, according to some embodiments.

FIG. 3D schematically illustrates the connecting mechanism of in FIG. 3C, during juxtaposing of the first and second ends of the herein disclosed tire-forming flexible tube, according to some embodiments.

FIG. 3E schematically illustrates the connecting mechanism of in FIG. 3C, after joining of the first and second ends of the herein disclosed tire-forming flexible tube, according to some embodiments.

FIG. 4 schematically illustrates one or more locking elements of a connecting mechanism, such as the connecting mechanism of FIG. 3C, according to some embodiments.

FIG. 5A schematically illustrates a one-way valve prior to/during insertion into a hole in a rim frame of a wheel, according to some embodiments.

FIG. 5B schematically illustrates a cross-section view of a one-way valve inserted into a rim frame and penetrating a tire-forming flexible tube, according to some embodiments.

FIG. 6A schematically illustrates the herein disclosed tire-forming flexible tube prior to insertion of a plurality of rods into a plurality of lumens of holding tubes of a tire-forming flexible tube, according to some embodiments.

FIG. 6B schematically illustrates the herein disclosed tire-forming flexible tube having inserted into its lumens a plurality of rods, such as the plurality of rods of FIG. 6A, according to some embodiments.

FIG. 7A schematically illustrates the herein disclosed tire-forming flexible tube prior to insertion of a plurality of interconnected rods into a plurality of lumens of holding tubes of a tire-forming flexible tube, according to some embodiments.

FIG. 7B schematically illustrates the herein disclosed tire-forming flexible tube having inserted into its lumen the plurality of interconnected rods, such as the rods of FIG. 7A, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

According to some embodiments, there is provided a tire-forming flexible tube with a first end and a second end, the first end and the second end of the tire-forming flexible tube configured to be joined together to form a tire.

As used herein, the term “wheel” a circular object that revolves on an axle and is fixed below a vehicle or other object to enable it to move easily over the ground. According to some embodiments, the wheel may include rim with a rim frame configured to receive a tire. According to some embodiments, the wheel further includes a hub or a wheel disc, and optionally spokes extending between the rim and the hub/wheel disc.

As used herein, the term “tire” refers to a ring-shaped component that surrounds a wheel's rim to transfer a vehicle's load from the axle through the wheel to the ground and to provide traction on the surface over which the wheel travels. Many tires are pneumatically inflated structures, which also provide a flexible cushion that absorbs shock as the tire rolls over rough features on the surface. The materials of tires are typically synthetic rubber, natural rubber, fabric and wire, along with carbon black and other chemical compounds. Tires typically include a tread and a body. The tread provides traction while the body provides containment for a quantity of compressed air, liquid or liquified foam. Other tires are solid/partially solid (not pneumatic). Tires are used on many types of vehicles, including light vehicles such as bicycles, motorcycles, mopeds, scooters and the like.

As used herein, the terms “tire-forming flexible tube” and “endless tire” may be used interchangeably and refer to an elongated member which when the ends of the elongated members are joined, form a tire with all its desired features.

The “tread” (also referred to herein as an “outer layer”) is the part of the tire (or tire-forming flexible tube) that comes in contact with the road surface. The tread is typically made of a thick rubber, or rubber/composite compound configured to provide an appropriate level of traction that does not wear away too quickly. The tread is often patterned to include circumferential grooves, lateral sipes, slots or a system of lugs and voids. The pattern is typically chosen to accommodate the type of terrain, weather, and frame/weight, of the vehicle. As a non-limiting example, grooves that run circumferentially around the tire, are typically used to channel away water. The “tire bead” is the part of the tire (or tire-forming flexible tube) that contacts the rim on the wheel and is configured to ensure that the tire does not shift circumferentially as the wheel rotates. The “sidewall” is that part of the tire (or tire-forming flexible tube), or bicycle tire, that bridges between the tread and bead. The sidewall is typically made largely of rubber, but may be reinforced with fabric or steel cords that provide for tensile strength and flexibility. According to some embodiments, the side wall may be made of a same material as the outer layer and optionally be an integral part thereof. According to some embodiments, the sidewall may be made of a different material than the outer layer.

According to some embodiments, the tire (or tire-forming flexible tube) may include an inner filament configured to be received in and optionally directly contact the rim of the wheel. According to some embodiments, the inner filament may extend between the thread and the tire bead. According to some embodiments, the inner filament may fill the void formed by the outer layer and the side walls. According to some embodiments, the part of the tire received within the rim of the wheel may be devoid of the sidewalls such that the inner filament directly contacts the rim. According to some embodiments, the inner filament may be enclosed circumferentially by the thread, sidewalls and optionally also a tire base wall, the tire base wall being in direct contact with the rim.

According to some embodiments, the tire-forming flexible tube comprising an outer layer made of a first elastomeric material (e.g., hard rubber), and an inner filament made of a second elastomeric material (e.g. soft rubber or foam).

According to some embodiments, the inner filament encloses one or more holding tubes, such as 1, 2, 3, 4, 5, or more holding tubes. The one or more holding tubes may be made of a strong yet flexible reinforced material such as polyamide 12/6 reinforced by carbon fibers. However, other polymers can likewise be envisaged. According to some embodiments, the one or more holding tubes are configured to increase the flexibility of the tire. According to some embodiments, the one or more holding tubes are configured to receive/hold therein compressed air (or other gas), liquid or liquified foam.

According to some embodiments, the diameter of one or more holding tubes may vary.

According to some embodiments, the inner filament further includes one or more longitudinal bores (e.g., 2, 3, 4, 5, 6 or more bores). Each possibility is a separate embodiment. According to some embodiments, the one or more longitudinal bores extend along the length of the tire-forming flexible tube. According to some embodiments, the longitudinal bores are configured to increase the flexibility of the tire-forming flexible tube. According to some embodiments, the longitudinal bores may have a same or a different dimension. As anon-limiting examples some bores (e.g. the closer to the sidewalls of the tire) may have a smaller diameter than other bores (e.g. those closer to the thread). It is understood that the cross-sectional shape of the bore is typically circular, oval or dome shaped. However, other shapes can also be envisaged and are as such encompassed within this disclosure. According to some embodiments, one or more of the bores may be configured to receive/hold therein compressed air (or other gas), liquid or liquified foam.

According to some embodiments, the tire-forming flexible tube may have an essentially dome shaped cross-section, wherein the base of the dome is sized and shaped to be received within a rim of a wheel. According to some embodiments, the side walls of the tire-forming flexible tube may include lateral slits configured to receive a rim frame of the wheel.

According to some embodiments, the tire-forming flexible tube may have an essentially uniform structure and shape along its length. As used herein, the term “essentially uniform structure” means wherever a cross sectional cut is made, along the length of the tire-forming flexible tube, the end face of the tube is essentially identical (except from minor productional differences (tolerance). Advantageously, this feature slows forming tires of different sizes (e.g. kid/adult wheel size) simply by adjusting the length of the tire-forming flexible tube prior to joining the ends thereof.

According to some embodiments, the tire may fit a variety of vehicles, in particular light vehicles, such as but not limited bicycles, scooters, mopeds, motorbikes and the like. Each possibility is a separate embodiment.

According to some embodiments, there is provided a spool comprising the herein disclosed endless tire.

According to some embodiments, there is provided a locking assembly (also referred to herein as a “lock” or “locking mechanism”) configured to irreversibly lock the first and second ends of the herein disclosed tire-forming flexible tube. The locking assembly includes one or more rods (such as 1, 2, 3, 4, 5, or more rods. Each possibility is a separate embodiment. According to some embodiments, the one or more rods are configured for insertion into one or more lumens of the holding tube of the tire-forming flexible tube. As used herein, the term “rod” refers to a straight or slightly bent or bendable stick or bar. According to some embodiments, the one or more rods may be non-hollow. According to some embodiments, the one or more rods may be hollow. According to some embodiments, the rod may be made of strong yet flexible reinforced material, such as but not limited to polycarbonate, reinforced polyamide (e.g., PA 12/6 reinforced by carbon fibers or reinforced by metallic parts (e.g. aluminum or steel rings). According to some embodiments, the outer diameter of the one or more rods is sized to fit, preferably in a tight-fit manner, within the respective holding tubes of the tire-forming flexible tube. According to some embodiments, all rods may have a same diameter. According to some embodiments, at least some of the rods may have a different diameter than other rods.

The one or more rods are configured to lock the first and second ends together upon joining thereof. This may for example be achieved by the one or more rods including anchoring elements on its outer surface, the anchoring elements configured to pinch into the wall of the holding tube and or the inner filament. According to some embodiments, the anchoring elements may be asymmetrical. A non-limiting example, of suitable asymmetrical anchors are anchors in the shape of a collared cone, as illustrated below. Another non-limiting example, of suitable asymmetrical anchors are spirals formed/extending along at least part of the first and second portions, in opposite directions (left/right-handed respectively). Another non-limiting example, of suitable asymmetrical anchors are spikes or barbs facing opposite directions. However, other asymmetrical anchors such as barbed wires or spikes can likewise be envisaged and a such are within the scope of this disclosure. According to some embodiments, a first portion of the anchors, positioned on a first portion of the one or more rods face a first direction while a second portion of the anchors, positioned on a second portion of the one or more rods face an opposite direction, thereby preventing rearward movement and detachment of the ends once joined.

According to some embodiments, the outer surface of the one or more rods further comprises a bulge increasing the outer diameter of the rod(s), such that when the first portion of the rod(s) is inserted into the lumen of the first end of the tire-forming flexible tube, the bulge serves as a stopper for further insertion. According to some embodiments, the bulge is positioned essentially in the center of the rod(s). According to some embodiments, the bulge extends circumferentially around the rod(s). According to some embodiments, the outer surface of the rod(s) may include more than one bulge, e.g., two oppositely positioned bulges.

According to some embodiments, the lateral surfaces of the bulge may have the size and shape of the end-face of the first and second ends of the tire-forming flexible tube. According to some embodiments, the lateral surfaces of the bulge may include an adhesive configured to glue together the first and second ends when joined. According to some embodiments, the adhesive may cover all or a portion of the lateral surfaces of the bulge.

Additionally or alternatively, the locking assembly may further include a disk comprising an adhesive on both its lateral surfaces. According to some embodiments, the disc may be a double-sided adhesive e.g., in the form of a self-adhesive washer. According to some embodiments, the disc has an essentially same cross section as the cross section of the tire-forming flexible tube. According to some embodiments, the disc has a slightly smaller circumference than the end-face of the tire-forming flexible tube, such that when the ends of the tire-forming flexible tube are pressed together the adhesive will remain between the joined end-faces. According to some embodiments, the disc includes a hole essentially in the center thereof, the hole having an inner diameter allowing the first portion of the rod to be inserted therethrough.

According to some embodiments, there is provided a connecting mechanism/tool (also referred to as “locking mechanism”, “tightening mechanism” and fixing mechanism”). The connecting mechanism is configured to assist in the joining together of the first and second ends of the tire-forming flexible tube, to form the ready to use tire assembled on the wheel. According to some embodiments, the connecting mechanism comprising: a first grasping element configured to grasp the first end of the tire-forming flexible tube, a second grasping element configured to grasp the second end of the tire-forming flexible tube, and a tightening element configured to interconnect the first and the second grasping elements.

According to some embodiments, the connecting mechanism is configured to juxtapose, optionally gradually, the first and second ends of the tire-forming flexible tube, until joining thereof. According to some embodiments, the tightening element may be a lever and the first grasping elements may serve as a ratchet. According to some embodiments, the first grasping element may include a ratchet handle configured to act on the lever for example by levering ratchet handle back and forth, thereby juxtaposing the first and second ends.

According to some embodiments, the second grasping element may include one or more locking elements (e.g., cam locks) configured to prevent the tire-forming flexible tube from escaping the rim of the wheel, during the juxtaposition of the first and second ends.

According to some embodiments, there is provided a one-way valve (also referred to as a “nipple”) configured to be inserted through a hole in the rim of the wheel and to penetrate the tire-forming flexible tube, e.g., as a result of the operation of the connecting mechanism. According to some embodiments, once valve has penetrated the tire such that it is partially inserted into the holding tube, air may be pumped into the holding tube via the valve. According to some embodiments, the one-way valve may include or have a distal end in the form of a needle or other sharp element configured to penetrate the outer layer, the inner filament, and the wall of the holding tube, as a result of the tightening of the connecting mechanism during assembly.

According to some embodiments, there is provided kit comprising the herein disclosed rod, and the herein disclosed connecting mechanism/tool. According to some embodiments, the kit further comprises the herein disclosed disc. According to some embodiments, the kit further comprises the herein disclosed one-way valve. According to some embodiments, the kit further comprises the herein disclosed tube-forming tire. According to some embodiments, the kit may further include a cutting tool configured to cute the tire-forming tube to its desirable length while preserving the integrity of the end-face thereof. According to some embodiments, the cutting tool may be a pruner or a guillotine-like cutter.

According to some embodiments, there is provided a method for assembling a tire on a wheel, the method comprising:
a) obtaining the herein disclosed tire-forming flexible tube;
b) optionally adjusting the length of the tire-forming flexible tube to a length suitable for use with the size of the wheel on which it is to be assembled;
c) inserting the tire-forming flexible tube into the rim of the wheel;
d) obtaining a rod configured for insertion into the lumen of the holding tube of the tire-forming flexible tube, the rod comprising two or more asymmetrical anchors on an outer surface thereof, wherein a first subset of the asymmetrical anchors, positioned on a first portion of the rod, are oppositely faced relative to the asymmetrical anchors positioned on a second portion of the rod;
e) inserting the first portion of the rod into the first end of the tire-forming flexible tube;
f) inserting a second portion of the rod into the second end of the tire-forming flexible tube;
g) attaching the connecting mechanism to the tire-forming flexible tube, such that a first grasping element thereof grasps the first end of the tire-forming flexible tube, a second grasping element thereof grasps the second end of the tire-forming flexible tube, and a tightening element thereof interconnects the first and second grasping elements;
h) juxtaposing the first and second ends of the tire-forming flexible tube using the connecting mechanism, until the first and second ends are joined; and
i) removing the connecting mechanism to obtain a wheel with a tire within the rim thereof.

According to some embodiments, the method further comprises sliding a disc (as essentially described herein) over the rod, prior to insertion of the second portion of the rod into the second end of the tire-forming flexible tube (step e), such that the disc be positioned between the first and second ends of the tire-forming flexible tube. Alternatively, the rod may be obtained with the disc already positioned thereof. According to some embodiments, the disc is a double-side washer adhesive, configured to glue together the first and second ends of the tire-forming flexible tube when joined, thereby preventing detachment of the joined first and second ends. According to some embodiments, the adhesive may be further configured to seal of holes and bores as required for wheels that need be filled with compressed air (or other gas), liquid or foam.

According to some embodiments, the juxtaposing of the first and second ends of the tire-forming flexible tube causes the anchors of the rod to anchor within the wall of the holding tube and/or within the inner filament of the tire-forming flexible tube, thereby preventing detachment of the joined first and second ends.

According to some embodiments, the rod comprises one or more bulges on its outer surface, preferably essentially in the center of the rod. According to some embodiments, the inserting the first portion of the rod into the first end of the tire-forming flexible tube comprises inserting the first portion of the rod until the one or more bulges prevents further insertion.

According to some embodiments, the method further comprises inserting a one-way valve into a hole in the rim of the wheel prior to the inserting of the tire-forming flexible tube into the rim of the wheel. According to some embodiments, the juxtaposing of the first and second ends causes the valve to penetrate the tire-forming flexible tube, such that a first end of the one-way valve is positioned within the lumen of the holding tube.

According to some embodiments, the method further comprises pumping air into the lumen of the holding tube, using the one-way valve.

As used herein, the term “about” may be used to specify a value of a quantity or parameter (e.g., the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 cm” is equivalent to the statement “the length of the element is between 0.8 cm and 1.2 cm”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “approximate” and “about” may be interchangeable.

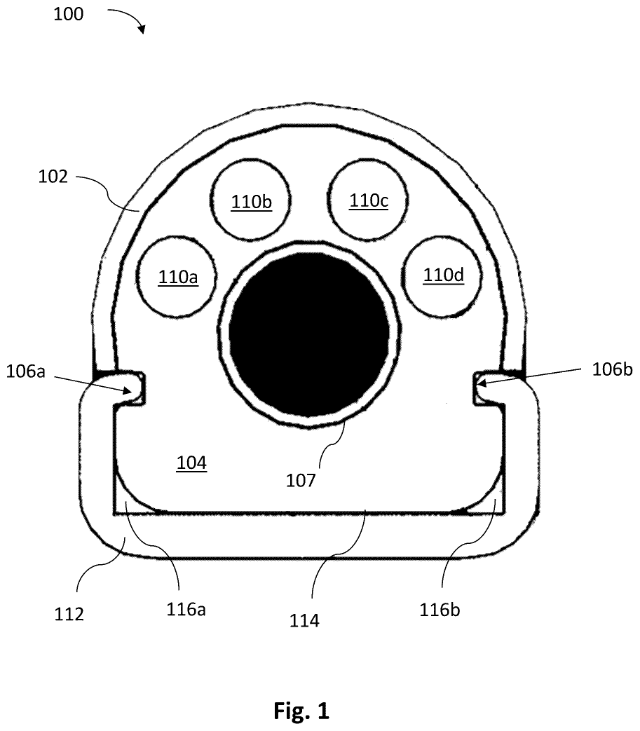

Reference is now made to FIG. 1, which schematically illustrates a cross-sectional view of a tire-forming flexible tube 100, according to some embodiments. According to some embodiments, tire-forming flexible tube 100 may include two layers: An outer layer 102 made of a first elastomeric material and an inner filament 104 made of a second elastomeric material. Inner filament 104 encloses a holding tube.

According to some embodiments, outer layer 102 may be made of a natural, synthetic polymer or combination of polymers. According to some embodies, the outer layer may be made of a natural and/or synthetic rubber. As a non-limiting example, the synthetic rubber may include a butadiene rubber and/or styrene butadiene rubber.

According to some embodiments, outer layer 102 may be made of or include a hard rubber. According to some embodiments, the outer layer 102 may have a Shore A hardness in the range of about 55 A-95 A. It is understood that the hardness values may be chosen according to the weather (winter/summer tires), terrain (e.g., road/off-road), weight of the vehicle, load and the like.

According to some embodiments, the outer layer 102 may include one or more layers of polymer (e.g. rubber) with different compositions, such that the outmost layer include the hardest layer, while the innermost layer include the softer layer, thereby providing graduated hardness properties.

According to some embodiments, the outer layer 102 may include reinforcing cords, such as polyester, rayon, nylon, aramid or metal cords or any combination thereof.

According to some embodiments, the outer layer 102 may include antioxidants and/or antiozonants for impeding the surface damaging effects originating from oxygen and/or ozone exposure.

According to some embodiments, the outer layer 102 may include a tread, such as a rubber tread. According to some embodiments, the outer layer 102 may include a smooth surface. According to some embodiments, the outer layer 102 may include a textured/patterned surface. According to some embodiments, the outer layer 102 may include studs to facilitate traction on ice and/or snow. According to some embodiments, the outer layer 102 may include blocks, spikes, grooves (e.g., longitudinal grooves), sipes (i.e. narrow voids), micro-sipes, dimples, slots, notches and any combination thereof. It is understood that the hereinabove listed properties of the outer layer 102 are aimed to facilitate the quality performance of the tire-forming flexible tube 100 in various scenarios. As a non-limiting example, the tire-forming flexible tube 100 used in cold winters may be made of a soft rubber and may include deep grooves and, optionally, studs, while the tire-forming flexible tube 100 used during “all seasons” may be made of a hard rubber (improving the wear resistance) and may further include shallow grooves and/or sipes to facilitate traction in dry weather.

According to some embodiments, the inner filament 104 may be made of natural or synthetic polymers or a combination thereof. According to some embodies, the outer layer may be made of a natural and/or synthetic rubber.

According to some embodiments, the inner filament 104 may be made of a soft rubber or a foam (optionally a foam of the same material as the outer layer). Non-limiting examples of suitable materials include silicone, epdm, butyl, nitrile, neoprene, polymer foam, or combinations thereof. According to some embodiments, the inner filament 104 may have higher flexibility than the outer layer 102.

According to some embodiments, the hardness values of the inner filament 104 may be lower than the hardness values of the outer layer 102. As a non-limiting example, the tire-forming flexible tube 100 may include the inner filament 104 with an approximate Shore A hardness value of about 55 A while the outer layer 102 with an approximate Shore A hardness value of about 85 A.

According to some embodiments, the inner filament 104 may be made of same polymers as the outer layer 102. According to some embodiments, the inner filament 104 and outer layer 102 may be made of different polymers. According to some embodiments, the inner filament 104 may further include reinforcing cords.

According to some embodiments, the inner filament 104 may include one or more longitudinal (axial) bores 110a, 110b, 110c, 110d (collectively referred to herein as one or more bores 110), configured to increase the flexibility of the tire-forming flexible tube 100. The number of bores may be designed for tailoring the softness of the tire-forming flexible tube based on purpose. As a non-limited example, and as shown in FIG. 1, the inner filament 104 may include four bores 110. Alternatively, the inner filament may include one, two, three, four, five, six, seven, eight, nine, ten, eleven, twelve bores or more bores. Each possibility is a separate embodiment.

According to some embodiments, bores 110 may have any cross-sectional shape such as circular, elliptical, rectangular, dome-like, and the like. According to some embodiments, all of bores 110 may have a same shape and/or dimension (e.g., diameter). Alternatively, bores 110 may vary in shape and/or dimension.

According to some embodiments, the bores 110 may be filled with a liquid or with air, as elaborated hereinafter.

According to some embodiments, inner filament 104 may enclose a holding tube 107 including a wall forming an open-ended lumen 108. According to some embodiments, holding tube 107 may include or be made of a polymeric material. According to some embodiments, the wall of holding tube 107 may be made of a strong yet flexible, preferably reinforced, such as but not limited to reinforced polycarbonate, reinforced polyamide (e.g. carbon fiber reinforced polyamide 6/12) or any other suitable, preferably reinforced polymer or combination of polymers.

According to some embodiments, open ended lumen 108 may be filled with air, as elaborated hereinafter.

According to some embodiments, tire-forming flexible tube 100 may include one or more lateral slits 106a and 106b (collectively referred to herein lateral slits 106). According to some embodiments, lateral slits 106 are geometrically complementary with a rim frame 112 of a wheel (now shown), thereby facilitating positioning and securing the tire-forming flexible tube 100 within a rim 114 of the wheel.

According to some embodiments, inner filament 104 may be fully contacting a surface of the rim 114. Alternatively, inner filament 104 may be partially contacting the surface of rim 114, thereby forming one or more voids 116a/116b.

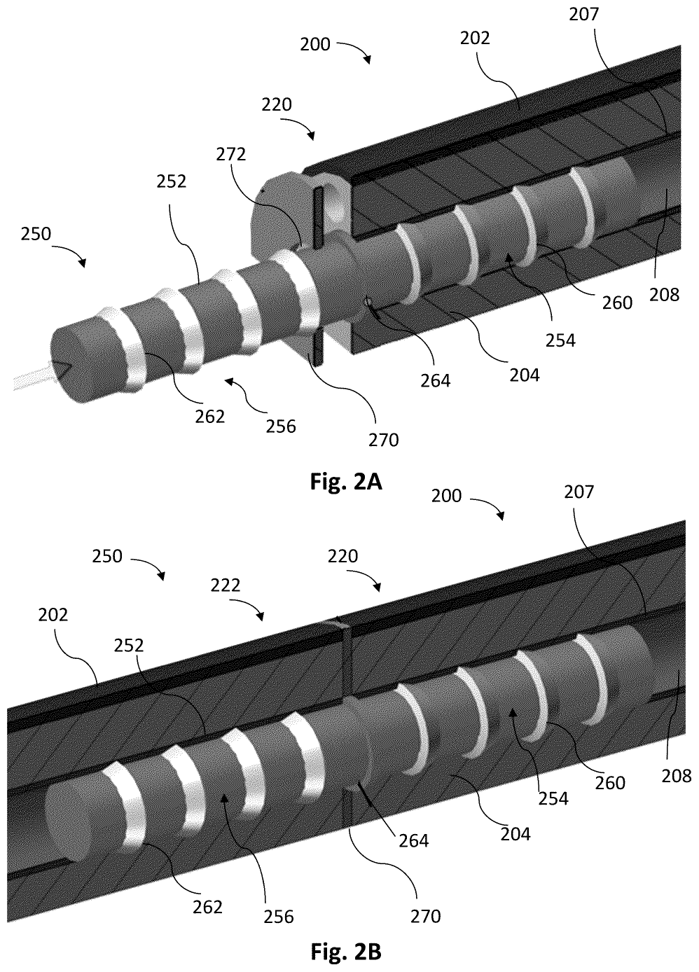

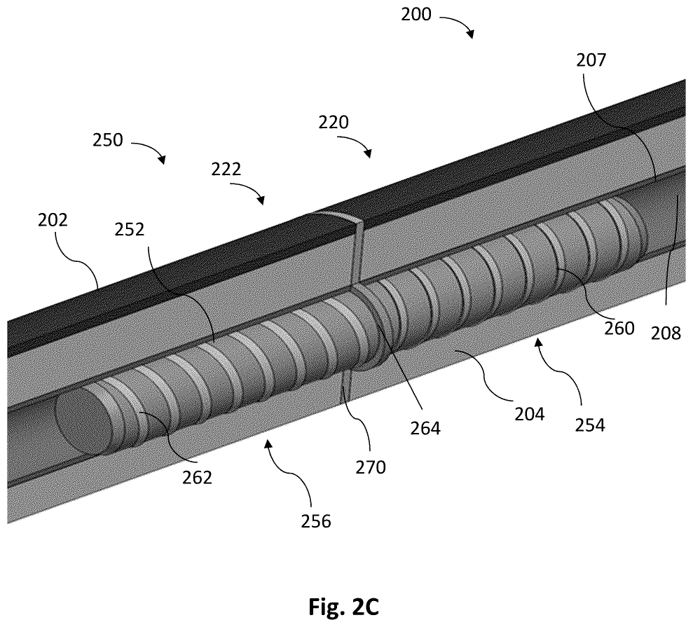

Reference is now made to FIG. 2A, which schematically illustrates a perspective view of a rod 250, according to some embodiments. According to some embodiments, rod 250 is configured to lock a first end 220 of a tire-forming flexible tube 200, such as the tire-forming flexible tube 100 of FIG. 1, with a second end thereof 222 (see in FIG. 2B).

According to some embodiments, the rod 250 may be made of or include a rigid or semi-rigid material. According to some embodiments, rod 250 may be made of a material rigid enough to withstand various push and pull forces yet flexible enough to allow the rod 250 to assume the curvature of wheels of various dimensions.

According to some embodiments, rod 250 may be made of or include polycarbonate, reinforced polyamide (e.g., PA 12/6 reinforced by carbon fibers or reinforced by metallic parts (e.g., aluminum or steel rings). According to some embodiments, rod 250 may be structured to provide a relatively high hardness and/or strength in a longitudinal direction, while providing a relatively high flexibility in a radial direction.

According to some embodiments, anchoring elements may be present on an outer surface 252 of the rod 250, anchors configured to pinch into a wall of a holding tube 207 and/or an inner filament 204.

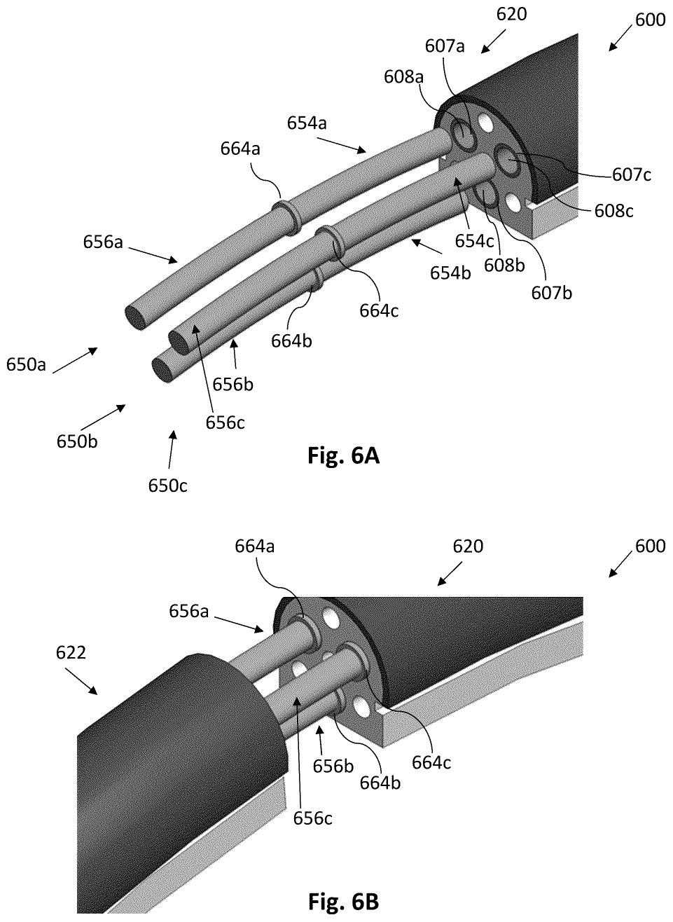

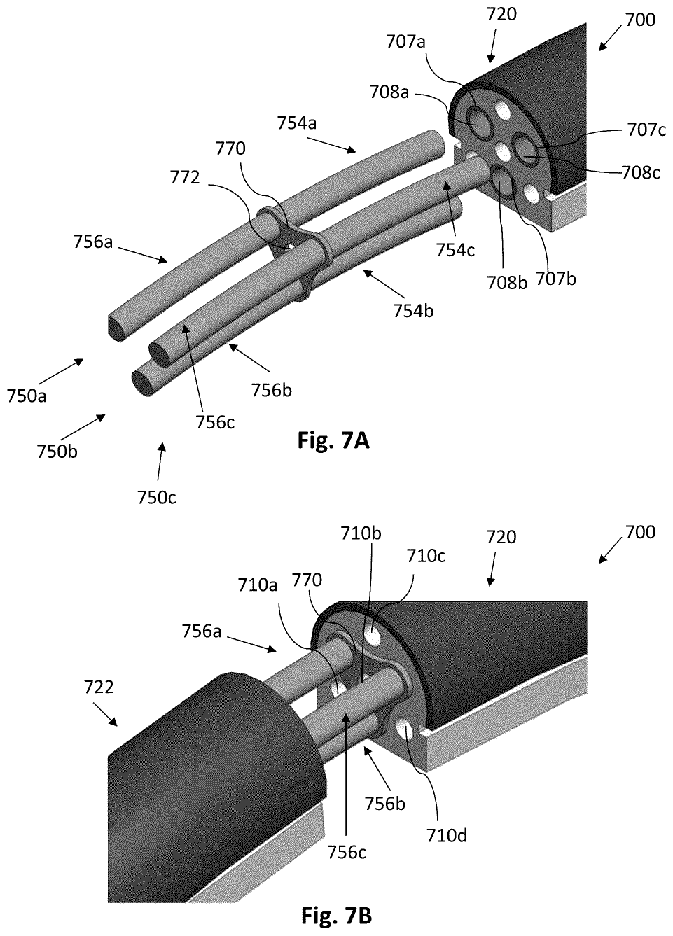

According to some embodiments, the anchors may include a plurality of cone-shaped collars 260/262, however other anchors such as a thread (illustrated in FIG. 2C below, spikes (not shown), barbs (not shown) or other anchors are also applicable and within the scope of this disclosure. In other embodiments, the rod(s) is devoid of anchors (as for example shown in FIG. 6A and FIG. 7A). In yet other embodiments, some of the rod may include and some be devoid of anchors (option not shown). In yet other embodiments, one portion of the rod(s) may be devoid of anchors while the other portion of the rod(s) may include anchors (option not shown). According to some embodiments, plurality of cone-shaped collars 260/262 include a first subset of the cone-shaped collars 260, positioned on a first portion 254 of rod 250, and a second subset of the cone-shaped collars 262, positioned on a second portion 256 of rod 250. According to some embodiments, each subset of the cone-shaped collars 260/262 faces toward an opposite direction, thereby preventing rearward movement of the first end 220 and the second end 222 of the tire-forming flexible tube 200.

According to some embodiments, each subset of the cone shaped collars 260/262 may include one, two, three, four, five or more cone-shaped collars. Each possibility is a separate embodiment.

According to some embodiments, cone shaped collars 260/262 may include or be made of ferrous (e.g., steel, stainless steel), non-ferrous (e.g. aluminium), composite, polymeric materials and the like. As a non-limiting example, collars 260/262 may be made of reinforced polyamide. As another, non-limiting example, collars 260/262 may be made of stainless steel.

According to some embodiments, rod 250 may include a bulge 264 increasing the outer diameter of the rod 250, such that when a first portion 254 of rod 250 is inserted into lumen 208 of the first end 220 of tire-forming flexible tube 200, bulge 264 serves as a stopper for further insertion.

According to some embodiments, bulge 264 may be positioned approximately in the center of rod 250. According to some embodiments, bulge 264 has an essentially same size and shape as first end 220 and the second end 222 of the tire-forming flexible tube 200.

According to some embodiments, bulge 264 may include or be made of a same material(s) as rod 250. According to some embodiments, bulge 264 may include or be made of different material(a) than rod 250.

According to some embodiments, outer surfaces of the bulge 264, such as the lateral surfaces, may include an adhesive layer configured to glue together the first end 220 and the second end 222 of tire-forming flexible tube 200, when joined. According to some embodiments, the adhesive layer may facilitate the sealing and prevent air loss from the joining/sealing area of the first end 220 and the second end of the tire-forming flexible tube 200. According to some embodiments, the adhesive layer may serve to prevent rotation of the first end 220 and second end 222 relative to one another. According to some embodiments, adhesive layer may be manually applied on the outer surfaces of bulge 264 before and/or during and/or after the insertion of the rod 250 into the first end 220 and/or the second end 222 of the tire-forming flexible tube 200, but before joining thereof.

According to some embodiments, rod 250 may include or be associated with a disc 270. According to some embodiments, disc 270 is made of or includes an adhesive, such as but not limited to 3M 08008 glue. According to some embodiments, both lateral surfaces of the disc 270 include the adhesive. According to some embodiments, disk 270 may facilitate sealing and prevent air loss from the joining/sealing area of the first end 220 and the second end 222 of the tire-forming flexible tube 200.

According to some embodiments, disk 270 is configured to fit the size and the dimensions (e.g. circumference) of the tire-forming flexible tube 200. According to some embodiments, disc 270 includes a hole 272, such that the inner diameter of the hole 272 allows insertion of the first portion 254 and/or the second portion 256 of the rod 250 therethrough.

According to some embodiments, disk 270 may be associated with bulge 264, such that the diameter of hole 272 fits the circumference of the bulge 264. According to some embodiments, disk 270 may be associated with rod 200 in the vicinity of the budge 264, e.g. adjacent to one of the lateral surfaces thereof. According to some embodiments, bulge 264 may prevent disc 270 from sliding over rod 250.

Reference is now made to FIG. 2B, which schematically illustrates a cross-section view of tire-forming flexible tube 200 after joining the ends thereof, according to some embodiments. According to some embodiments, disk 270 may be positioned on bulge 264 of rod 250, such that the outer circumference of disk 270 is essentially equal to the circumference of outer layer 202 of tire-forming flexible tube 200, thereby preventing air loss/leakage from the joining/sealing area of the first end 220 and the second end 222 of tire-forming flexible tube 200.

According to some embodiments, there is provided a method for assembling the disclosed herein tire-forming flexible tube. It is understood by one of ordinary skill in the art that the steps, as outlined below, may not necessarily be carried out in the indicated order. The order of at least some of the steps may be changed, be carried out simultaneously, or be carried out separately from the procedure, as readily understood by one of ordinary skill in the art.

Reference is now made to FIG. 2C, which schematically illustrates cross-section view a tire-forming flexible tube 200 after joining the ends thereof, according to some embodiments having inserted therein a rod 250. According to some embodiments. Rod 250 may be essentially similar to rod 250 of FIG. 2A except that in this case rod 250 includes a first thread 260 facing a first direction and a second thread 262 facing a second direction, instead of cone-shaped collars 260 and 262, respectively. Threads, 260 and 262 may be configured to be screwed into wall of holding tube 207, thereby fixing first end 220 and 222 of tire-forming tube 200 to each other.

According to some embodiments, threads 260 and 262 may include or be made of ferrous (e.g., steel, stainless steel), non-ferrous (e.g. aluminium), composite, polymeric materials and the like. As a non-limiting example, threads 260 and 262 may be made of reinforced polyamide. As another, non-limiting example, threads 260 and 262 may be made of stainless steel.

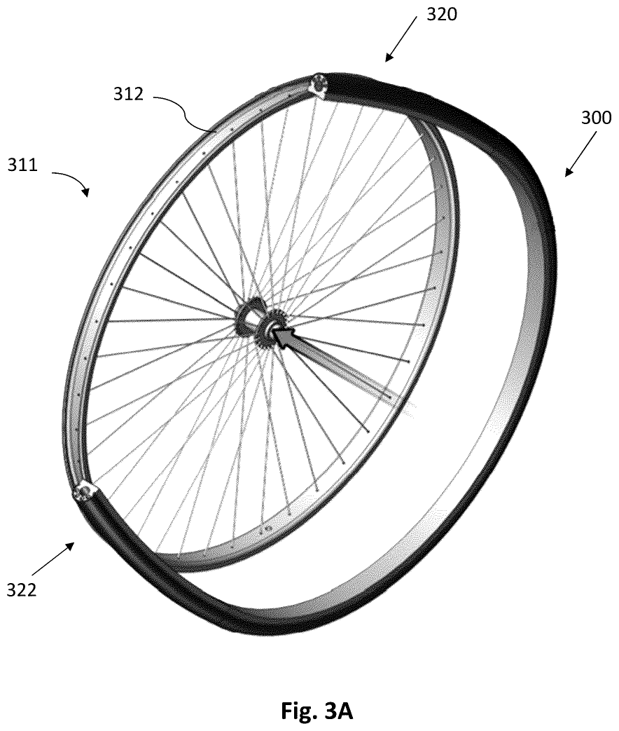

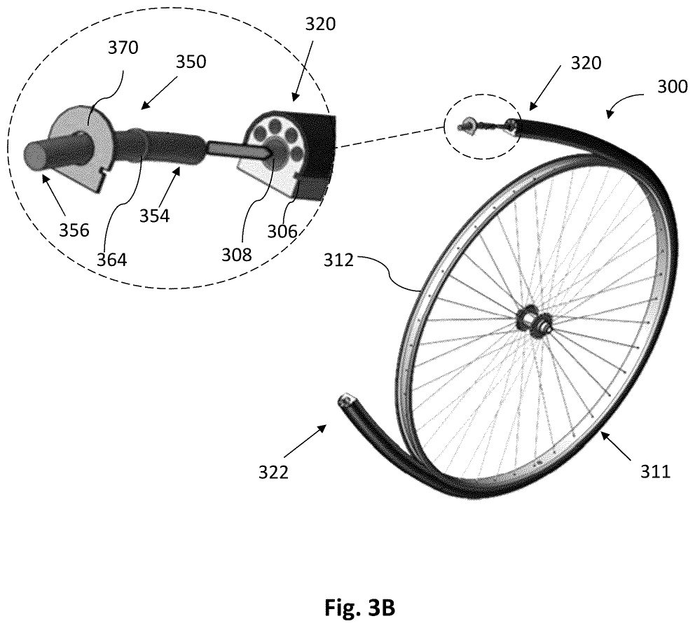

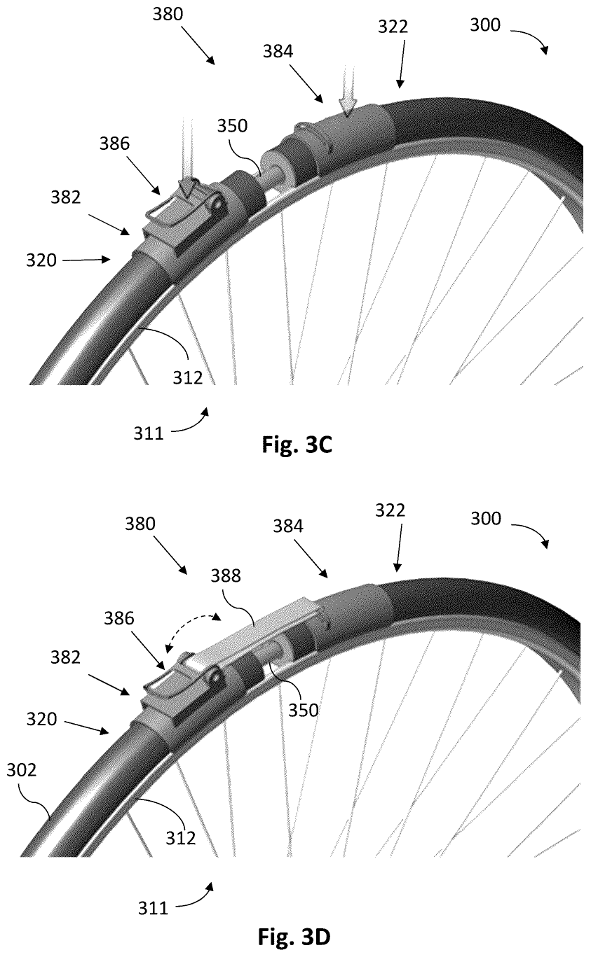

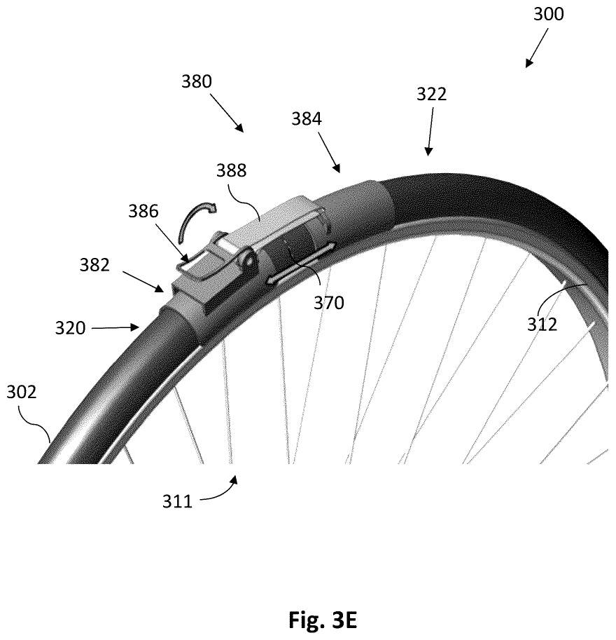

Reference is now made to FIG. 3A, which schematically illustrates a tire-forming flexible tube 300 configured to be assembled on a wheel 311, according to some embodiments. Tire-forming flexible tube 300 includes a first end 320 and a second end 322.

According to some embodiments, the length of tire-forming flexible tube 300 is configured to tightly fit the circumference of a rim frame 312.

According to some embodiments, the disclosed method may include cutting the tire-forming flexible tube 300 to the required length (such as but not limited to about 1.94 m) so as to fit a wheel of a desired size. According to some embodiments, tire-forming flexible tube 300 may be cut from a spool, thereby advantageously allowing storing one spool and tailoring the desired length to a variety of wheel sizes. According to some embodiments, tire-forming flexible tube 300 may be obtained and/or stored in advance, with the required length.

Optionally, in some embodiments, the disclosed method may include adjusting the length of tire-forming flexible tube 300 (e.g., by cutting) by matching the length of tire-forming flexible tube 300 to wheel 311 on which it is to be assembled.

Reference is now made to FIG. 3B, which schematically illustrates inserting the tire-forming flexible tube 300 into a rim frame 312 of wheel 311, according to some embodiments. According to some embodiments, tire-forming flexible tube 300 may include lateral slits 306, configured to receive the rim frame 312 of wheel 311 thereby and securing the tire-forming flexible tube 300 within rim frame 312 of wheel 311.

According to some embodiments, the method for assembling the herein disclosed tire-forming flexible tube 300 includes obtaining a rod 350 (such as but not limited to rod 250 of FIG. 2).

According to some embodiments, rod 350 may include two or more asymmetrical anchors (e.g., as previously shown in FIG. 2A) on an outer surface thereof. According to some embodiments, a first subset of the asymmetrical anchors, positioned on a first portion 354 of rod 350, are oppositely faced relative to the asymmetrical anchors positioned (e.g., as previously shown in FIG. 2A) on a second portion 356 of rod 350.

According to some embodiments, the disclosed method includes inserting rod 350 into tire-forming flexible tube 300. Specifically, the method may include inserting a first portion 354 of rod 350 into the first end 320 of tire-forming flexible tube 300, according to some embodiments.

According to some embodiments, the inserting comprises pushing first portion 354 of rod 350 into the first end 320 of tire-forming flexible tube 300 until a bulge (stopper) 364 prevents further insertion.

According to some embodiments, the disclosed herein method may further include placing/sliding a disk 370 onto rod 350. According to some embodiments, disk 370 may be made of an adhesive. According to some embodiments, disk 270 may include an adhesive layer on the lateral surfaces thereof, the adhesive configured to facilitate sealing and prevent air loss from the joining/sealing area of the first end 320 and the second end 322 of the tire-forming flexible tube 300.

According to some embodiments, the disclosed herein method may include inserting a second portion 356 of rod 350 into the second end 322 of tire-forming flexible tube 300.

Reference is now made to FIG. 3C, which schematically illustrates the attaching of a connecting mechanism/tightening mechanism 380 to tire-forming flexible tube 300, according to some embodiments. Specifically, according to some embodiments, a first grasping element 382 of connecting mechanism 380 grasps first end 320 of tire-forming flexible tube 300, a second grasping element 384 thereof grasps second end 322 of the tire-forming flexible tube 300, and a tightening element 388 thereof interconnects first grasping element 382 and second grasping element 384.

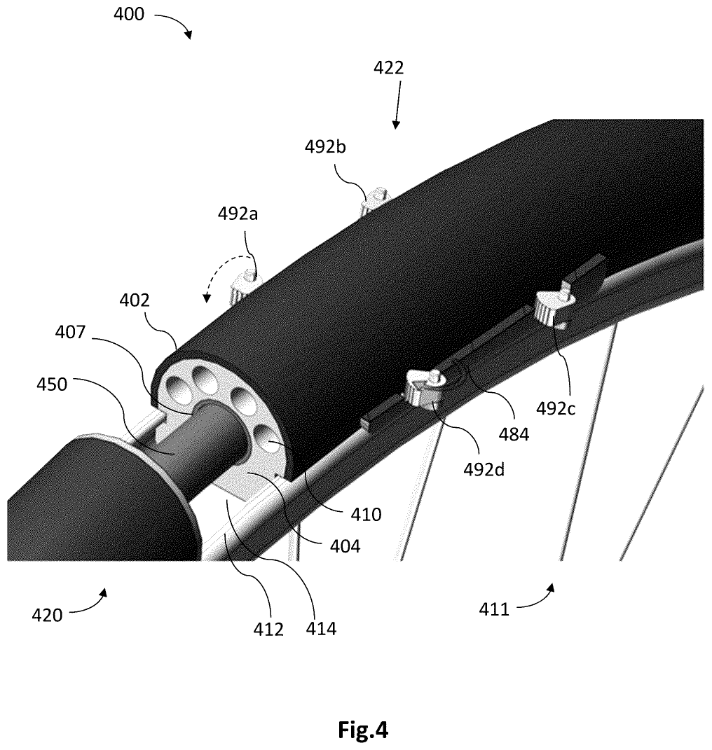

According to some embodiments, connecting mechanism 380 may be associated with rim frame 312 at a designated/pre-defined position. According to some embodiments, connecting mechanism/tightening mechanism 380 may be associated with rim frame 312 at any position on rim frame 312. According to some embodiments, connecting mechanism 380 may include one or more locking elements, as further elaborated and depicted in FIG. 4.

According to some embodiments, the inner circumference of first grasping element 382 and second grasping element 384 may fit the outer circumference of tire-forming flexible tube 300, thereby allowing grasping and juxtaposing first end 320 and second end 322 of tire-forming flexible tube 300.

Reference is now made to FIG. 3D, which schematically illustrates the juxtaposing of first end 320 and second end 322 of tire-forming flexible tube 300, until joining thereof, according to some embodiments. According to some embodiments, the disclosed method may include juxtaposing first end 320 and second end 322 of tire-forming flexible tube 300 using connecting mechanism/tightening mechanism 380. According to some embodiments, the juxtaposing comprises juxtaposing first end 320 to second end 322. According to some embodiments, the juxtaposing comprises juxtaposing first end 320 and second end 322 toward each other.

According to some embodiments, tightening element 388 may include a lever. According to some embodiments, first grasping element 382 may include a handle 386, e.g. a rachet handle. As a non-limiting example, first end 320 and second end 322 of tire-forming flexible tube 300 may be juxtaposed by levering handle 386 of first grasping element back and forth (e.g., as marked by a dashed arrow in FIG. 3D) until first end 320 and second end 322 of tire-forming flexible tube are fully joined.

According to some embodiments, disk 370 may be adjacent to or placed over a bulge 364 of rod 350, at the join between first end 320 and second end 322, thereby gluing together first end 320 and second end 322.

According to some embodiment, juxtaposing first end 320 and second end 322 of tire-forming flexible tube 300 may be performed gradually, e.g., by repeating back and forth movements of handle 386. According to some embodiments, juxtaposing first end 320 and second end 322 of tire-forming flexible tube 300 may be performed at one step.

Reference is now made to FIG. 3E, which schematically illustrates the connecting mechanism 380 of FIG. 3C, after joining of the first end 320 and the second end 322 of the herein disclosed tire-forming flexible tube 300, according to some embodiments.

According to some embodiments and as depicted in FIG. 3E, disk 370 may be visible on an outer surface 302 of tire-forming flexible tube 300, following the joining. Alternatively, disk 370 may be concealed from outer surface 302 thereof.

According to some embodiments, the disclosed herein method may optionally include applying an adhesive on the outer circumference of the juxtaposed tire-forming flexible tube 300, for preventing air loss from the juxtaposed region. According to some embodiments, a short period of time (e.g., 5 seconds, 10 seconds, 30 seconds, 1 minute, 2 minutes or more) may be provided for bonding and/or drying the adhesive.

According to some embodiments, the disclosed method further includes removing connecting mechanism 380, thereby obtaining wheel 311 with a tire within rim frame 312 thereof.

Reference is now made to FIG. 4, which schematically illustrates one or more locking elements 492a, 492b, 492c and 492d (collectively referred herein as one or more locking elements 492) attached to or lean on a rim frame 412 of a wheel 411, according to some embodiments. According to some embodiments, locking elements 492 may be part of connecting mechanism. For example, locking elements 492 may be poisoned on grasping element 484 (partially shown). FIG. 4 further schematically depicts a tire-forming flexible tube 400 including an outer layer 402, one or more longitudinal (axial) bores 410, and an inner filament 404 enclosing a holding tube 407, following insertion (and before juxtaposing) a rod 450 into a first end 420 and a second end 422 of tire-forming flexible tube 400, according to some embodiments.

According to some embodiments, one or more locking elements 492 may be used for preventing displacement and/or escaping of tire-forming flexible tube 400 from rim frame 412.

According to some embodiments, one or more locking elements 492 may be configured to apply a considerable amount of pressure, i.e., securing the tire-forming flexible tube 400 in wheel rim 414 while allowing juxtaposing first end 420 and second end 422 of tire-forming flexible tube 400. According to some embodiments, one or more locking elements 492 are configured to rotate (e.g., as marked by a dotted arrow in FIG. 4) during juxtaposing, thereby minimizing the required energy juxtaposing for first end 420 and second end 422 while preventing displacement of tire-forming flexible tube 400 from rim 414. As a non-limiting example, one or more locking elements 492 may be or include cam locks.

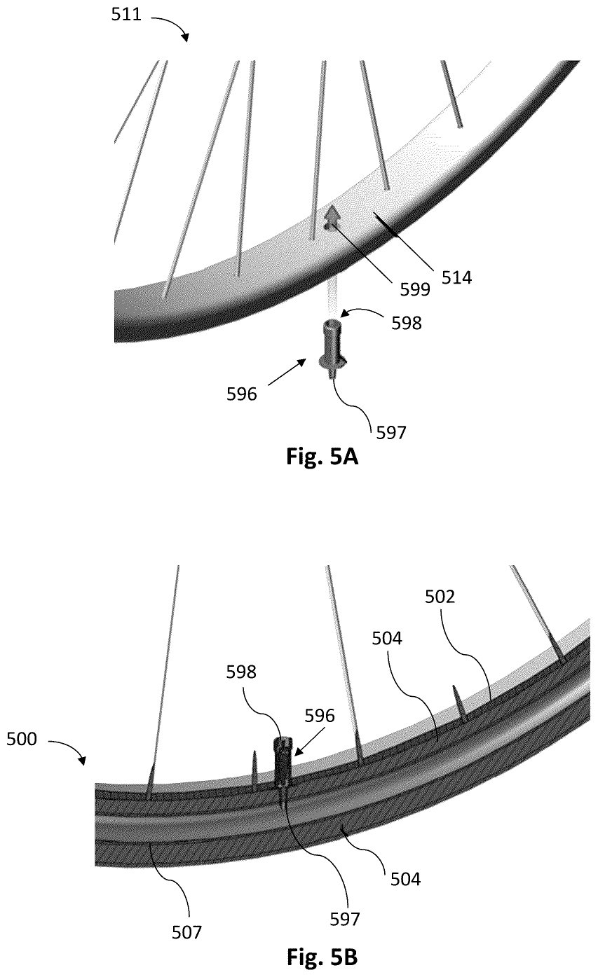

Reference is now made to FIG. 5A, which schematically illustrates inserting a one-way valve 596 into a hole 599 in a rim 514 of a wheel 511, prior to the inserting of a tire-forming flexible tube 500 (seen in FIG. 5B), according to some embodiments. According to some embodiments, one-way valve 596 may include an opening 598 configured to receive a pump and/or pump connector, e.g., air pump.

Reference is now made to FIG. 5B, which schematically illustrates a cross-section of one-way valve 596 inserted into rim frame 512 and a tire-forming flexible tube 500, according to some embodiments. According to some embodiments, one-way valve 596 may include a distal end 597 in the form of a needle or other sharp element configured to penetrate an outer layer 502, an inner filament 504, and of a wall of a holding tube 507.

According to some embodiments, the disclosed herein method may include pumping air (or other gas), liquid or liquified foam into the assembled tire-forming flexible tube 500 via one-way valve 596. According to some embodiments, one-way valve 596 may include a stripper (not shown), configured to fill one or more longitudinal (axial) bores (not shown) with air or liquid substance, thereby increasing the flexibility of tire-forming flexible tube 500.

Reference is now made to FIG. 6A, which schematically illustrates a tire-forming flexible tube 600 prior to insertion of a plurality of rods 650a, 650b and 650c (collectively referred to herein rods 650), according to some embodiments. Specifically, according to some embodiments, rods 650 are configured to be inserted into lumens 608a, 608b and 608c (collectively referred to as lumens 608) of holding tubes 607a, 607b, and 607c (collectively referred to herein as holding tubes 607).

As depicted in FIG. 6A, each of rods 650 includes a first portion 654 and a second portion 656. According to some embodiments, first portion 654 of one or more rods 650 is configured to be inserted into the lumens of a first end 620, and second portion 656 is configured to be inserted into the lumens of a second end 622 (see FIG. 6B) of the tire-forming tube 600.

According to some embodiments, rods 650 is here shown to include 3 rods however, other number of rods, such as 2, 4, 5, or more can also be envisaged and as such is within the scope of this disclosure. Similarly tire-forming flexible tube 200 is here shown to include three holding tubes/lumens however, other number of holding tubes/lumens, such as 2, 4, 5, or more holding tubes/lumens (matching the number of rods) can also be envisaged and as such is within the scope of this disclosure.

According to some embodiments, rods 650 may be essentially similar. In some embodiments, the size (e.g., length, diameter) and the geometry (e.g. cross-section type) of each of the rods 650 may vary/differ.

According to some embodiments, first portion 654 of each of rods 650 may be inserted simultaneously into lumens 608. Alternatively, first portion 654 of each of rods 650 may be subsequently inserted into lumens 608.

According to some embodiments, an adhesive may be applied on outer surfaces of rods 650 prior to the insertion into the tire-forming flexible tube 600, to facilitate joining of first end 620 and second end 622 of the tire-forming flexible tube 600. According to some embodiments, adhesive may be inserted into lumens 608 prior to the insertion of rods 650.

According to some embodiments, rods 650 may optionally include asymmetrical anchors (not shown), as essentially described herein.

According to some embodiments, the insertion of rods 650 may be performed manually and/or automatically. As a non-limiting example, the automatic insertion may include electric insertion. Different scenarios wherein the manual insertion may be beneficial may include field conditions (minimizing the required equipment). However, scenarios wherein the automatic insertion may be beneficial may include commercial places, such as stores, auto repair shops, garages, and the like.

Reference is now made to FIG. 6B, which schematically illustrates the herein disclosed tire-forming flexible tube 600 during the insertion of rods 650, according to some embodiments. According to some embodiments and as shown in FIG. 6B, first portion 654 of each of rods 650 is fully inserted into first end 620 of tire-forming flexible tube 600, while second portion 656 of rods 650 is partially inserted into second end of tire-forming flexible tube 600.

According to some embodiments, each of rods 650 may include a bulge 644a, 644b and 644c.

According to some embodiments, a complete insertion of rods 650 may be achieved when no further juxtaposing can occur (i.e., upon reaching of bulges 644a, 644b and 644c from both sides thereof).

Reference is now made to FIG. 7A, which schematically illustrates a tire-forming flexible tube 700 prior to insertion of a plurality of interconnected rods 750a, 750b and 750c (collectively referred to herein as rods 750). Specifically, according to some embodiments, rods 750 are configured to be inserted into lumens 708a, 708b and 708c (collectively referred to as lumens 708) of holding tubes 707a, 707b, and 707c (collectively referred to as holding tubes 707).

According to some embodiments, each of rods 750 include a first portion 754a, 754b, 754c (collectively referred to as first portion 754) and a second portion 756a, 756b, 756c (collectively referred to as second portion 756), respectively.

According to some embodiments, rods 750 may be associated with a disk 770. According to some embodiments, rods 750 may be permanently associated with disk 770. According to some embodiments, disk 770 may be attached to one or more rods 750 after inserting the first portion 754 of one or more rods 750 into one or more lumens 708.

According to some embodiments, disk 770 may serve as a stopper for further insertion into lumens 708.

According to some embodiments, disk 770 may be made of or include an adhesive configured to glue together a first end 720 and a second end 722 (shown in FIG. 7B) of tire-forming flexible tube 700 when joined. According to some embodiments, adhesive may be applied to disk 770 prior to joining first end 720 and second end 722 of tire-forming flexible tube 700.

Reference is now made to FIG. 7B, which schematically illustrates the herein disclosed tire-forming flexible tube 700 during the insertion of rods 750, according to some embodiments. According to some embodiments and as shown in FIG. 7B, first portion 754 of each of rods 750 is fully inserted into first end 720 of tire-forming flexible tube 700, while second portion 756 of rods 750 is partially inserted into second end of tire-forming flexible tube 700.

According to some embodiments, tire-forming flexible tube 700 may include one or more longitudinal (axial) bores, here four bores 710a, 710b, 710c, 710d (collectively referred to herein bores 710), configured to increase the flexibility of the tire-forming flexible tube 700. The number of bores may be designed for tailoring the softness of the tire-forming flexible tube based on purpose. According to some embodiments, one or more bored may be filled with air and/or liquid.

According to some embodiments, disk 770 may include one or more holes 772 (matching the number of bores/rods). One or more holes 772 have an inner diameter essentially equal to or larger than the diameter of one or more bores 710, allowing air and/or liquid flow therethrough. According to some embodiments, one or more hole 722 may be configured to allow associating of disk 770 with one or more rods 750.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

1.-30. (canceled)

31. A tire-forming flexible tube having a first end and a second end, the tire-forming flexible tube comprising an outer layer made of a first elastomeric material, and an inner filament made of a second elastomeric material, the inner filament enclosing a holding tube, wherein the first end and the second end of the tire-forming flexible tube are configured to be joined together to form a tire.

32. The tire-forming flexible tube of claim 31, wherein the holding tube comprises a wall made of a reinforced polymeric material, the wall forming an open-ended lumen.

33. The tire-forming flexible tube of claim 31, wherein the first elastomeric material has a higher flexibility and/or lower hardness than the second elastomeric material.

34. The tire-forming flexible tube of claim 31, wherein the first elastomeric material comprises a hard rubber or other polymeric material and wherein the second elastomeric material comprises a soft rubber or a foam.

35. The tire-forming flexible tube of claim 31, wherein the inner filament comprises one or more longitudinal bores extending along the length of the tire-forming flexible tube, the longitudinal bores configured to increase the flexibility of the tire-forming flexible tube.

36. The tire-forming flexible tube of claim 31, having an essentially dome shaped cross-section, wherein the base of the dome is sized and shaped to be received within a rim of a wheel and wherein the base of the dome comprises lateral slits, the lateral slits configured to receive a rim frame of the wheel.

37. The tire-forming flexible tube of claim 31, having an essentially uniform structure and shape along its length, such that the size of the tire, formed upon joining of the first and second ends, is determinable by adjustment of the length of the tire-forming flexible tube.

38. The tire-forming flexible tube of claim 31, wherein the wheel is selected from a bicycle wheel, a scooter wheel, a moped wheel a motorcycle wheel or any combination thereof.

39. A locking assembly configured to connect together the first and second ends of the tire-forming flexible tube of claim 31, the locking assembly comprising a rod configured for insertion into the lumen of the holding tube, the rod comprising two or more asymmetrical anchors or a glue on an outer surface thereof, wherein a first subset of the two or more asymmetrical anchors, positioned on a first portion of the rod, are oppositely faced relative to a second subset of the two or more asymmetrical anchors, positioned on a second portion of the rod.

40. The locking assembly of claim 39, wherein the two or more asymmetrical anchors are configured to anchor within the wall of the holding tube and/or within the inner filament, thereby persisting detachment of the joint-together first and second ends.

41. The locking assembly of claim 39, wherein an outer diameter of the rod is sized to fit within the lumen of the holding tube.

42. The locking assembly of claim 39, wherein the outer surface of the rod further comprises a bulge increasing the outer diameter of the rod, such that when the first portion of the rod is inserted into the lumen of the first end of the tire-forming flexible tube, the bulge serves as a stopper for further insertion, wherein the bulge extends circumferentially around the rod, and wherein lateral surfaces of the bulge comprise an adhesive configured to glue together the first and second ends, when joined.

43. The locking assembly of claim 39, further comprising a disk comprising an adhesive on both its lateral surfaces, wherein the disk has an essentially same cross section, as the cross section of the tire-forming flexible tube and wherein the disk comprises a hole having an inner diameter allowing the first portion of the rod to be inserted therethrough.

44. A tire-forming system comprising:
a tire-forming flexible tube having a first end and a second end, the tire-forming flexible tube comprising an outer layer made of a first elastomeric material, and an inner filament made of a second elastomeric material, the inner filament enclosing a holding tube, wherein the first end and the second end of the tire-forming flexible tube are configured to be joined together to form a tire;
a locking assembly configured to connect together the first and second ends of the tire-forming flexible tube, the locking assembly comprising a rod configured for insertion into the lumen of the holding tube, the rod comprising two or more asymmetrical anchors or a glue on an outer surface thereof, wherein a first subset of the two or more asymmetrical anchors, positioned on a first portion of the rod, are oppositely faced relative to a second subset of the two or more asymmetrical anchors, positioned on a second portion of the rod;
and a connecting mechanism configured to join together the first and second ends of the tire-forming flexible tube, the connecting mechanism comprising: a first grasping element configured to grasp the first end of the tire-forming flexible tube, a second grasping element configured to grasp the second end of the tire-forming flexible tube, and a tightening element configured to interconnect the first and the second grasping elements, wherein the connecting mechanism is configured to juxtapose the first and second ends of the tire-forming flexible tube until joining thereof.

45. The tire-forming system of claim 44, wherein the tightening element comprises a lever and the first grasping element comprises a ratchet handle configured to act on the lever to juxtapose the first and second ends.

46. The tire-forming system of claim 44, wherein the second grasping element comprises one or more locking elements configured to prevent the tire-forming flexible tube from escaping the rim of the wheel during the juxtaposition of the first and second ends.

47. The tire-forming system of claim 46, wherein the one or more locking elements comprises cam locks.

48. The tire-forming system of claim 44, further comprising a one-way valve configured to penetrate the tire-forming flexible tube, so as to allow pumping of air, liquid or liquefied foam into the holding tube thereof.
